(19) United States
(12) Patent Application Publication
(10) Pub. No.: US 2007/0039894 A1
(43) Pub. Date: Feb. 22, 2007

(54) Water treatment using magnetic and other field separation technologies

(76) Inventor: Steven L. Cort, Cary, NC (US)

Correspondence Address: Michael de Angeli, 60 Intrepid Lane, Jamestown, RI, 02835, US

(21) Appl. No.: 11/503,951

(22) Filed: Aug. 15, 2006

Related U.S. Application Data
(60) Provisional application No. 60/708,789, filed on Aug. 17, 2005.

(51) Int. Cl. C02F 1/48

(52) U.S. Cl. 210/695; 210/738; 210/223

(57) ABSTRACT

Apparatus and methods for removal of pollutants from a stream of water, by binding the pollutant particles to magnetic seeding particles using a flocculating polymer, and then removing the composite magnetic particles from the water stream in a simple and efficient apparatus. The invention is applicable to many common water treatment applications but is especially important for high flow applications requiring efficiency and simplicity. Magnetic fields concentrate the composite magnetic particles in a stratified layer that is then continually separated from the moving stream of water. In another preferred embodiment, vortex separation is combined with magnetic separation to enhance magnetic seed material cleaning and to reduce the solids load on the final magnetic collector.

### CROSS-REFERENCE TO RELATED APPLICATION

This application claims priority from Provisional Application Ser. No. 60/708,789 filed Aug. 17, 2005.

### FIELD OF THE INVENTION

This invention relates to removing fine particles, including metal precipitates, organic solids, inorganic solids, clays, silts, oil and grease, and any other hard to remove fine solids from water. It is applicable to industrial wastewater, municipal wastewater, potable water, combined sewer overflow, storm water, process water, cooling water and any other waters that require clarification to remove fine particles. The invention relates to the use of magnetic separation technology where a fine magnetic seed material, preferably magnetite (a magnetic form of iron oxide), is added to water along with an organic flocculating polymer. The organic flocculating polymer binds the non-magnetic pollutant particles to the magnetic seed material, so that the composite particles can then be removed magnetically from the water. The magnetic seed material is then cleaned and reused. Specifically, this application describes novel ways for improving the efficiency of magnetic separation technology by combining it with other field separation technologies, particularly vortex separation, to enhance the removal of fine particles from water. This application also presents new passive magnetic collector designs that use no scrapers to remove magnetic material from permanent magnet collectors.

### BACKGROUND OF THE INVENTION

Magnetic seeding technology has been commercially used to clean water for many years. Broadly speaking, and as described in the inventor's prior U.S. Pat. No. 6,896,815 (which is incorporated herein by this reference), particles to be removed, whether these are dirt, silt, or the like that occur in the water stream to be treated, or chemically precipitated particles as emphasized in the '815 patent, can be removed from the water stream without filtration by causing them to be bound up with magnetic particles allowing the composite particles thus formed to be removed using magnetic attraction to separate out the composite particles from the water stream. The pollutant particles can be bound to the magnetic particles using flocculant material, typically an organic polymer. The present invention relates to novel simple and efficient methods and apparatus used to remove the composite magnetic particles from the water stream.

A known commercial application of magnetic seeding is the “Sirofloc” technology offered by Aker Kvaemer of Stockton-on-Tees, England to clean drinking water. This process uses the absorption capacity of magnetite to remove color and other pollutants from water. The spent magnetic seed material (magnetite) settles out by gravity in a clarifier and then is pumped to a magnetite regeneration step that cleans the magnetite chemically so it can be reused.

Another known commercial application of magnetic seeding is the “CoMag” process described in Wechsler U.S. Pat. No. 6,099,738. This process requires a magnetic collector that uses powerful electromagnets to create a high gradient magnetic field. Once the collector becomes loaded with solids, it is backwashed with air and water to flush the magnetic seed material to a cleaning process. The cleaned magnetic seed material is then reused in the treatment process. The electromagnets in the CoMag system have to be de-energized for cleaning. The cleaning process interrupts the flow of water for treatment and high solids loading limits the ability to backwash the system.

Vortex separation techniques, operating on the principle of separating solids from water by the centrifugal forces created in a vortex, have been used, for example, to clean large flows from stormwater and combined sewer overflow (CSO) sources. The more dense solid particles are forced to the center of the vortex and the clear water migrates to the outside of the vortex, allowing separation of the stream into relatively clean and relatively pollutant-laden fractions. The main disadvantage of this technology as conventionally employed is that fine particles, e.g., less than 200 microns, are not dense enough to be effectively separated by the vortex separator in the allotted residence time.

As above, the present inventor has been granted U.S. Pat. No. 6,896,815 for the use of particle separation methods in a two-step process that uses hydroxide and sulfide precipitation. The separation methods for removing fine pollutant particles from water include magnetic separation, gravity clarification, dissolved air flotation, buoyant plastic flotation, vortex separation, and any other method that uses field separation rather than filtration to remove particles from water. In an embodiment employing magnetic separation, a magnetic seed material is added to water that contains fine pollutant particles. The seed material is attached to the pollutant particles with an organic flocculating agent. The flocculated composite particles are now magnetic allowing their removal from the water with either permanent magnets or electromagnets. Continuation-in-part application Ser. No. 11/135,644 further describes the design features of the magnetic separation apparatus, specifically, the design of the final magnetic collector and the benefits of locating the final magnetic collector in the flocculation tank.

A major disadvantage with known magnetic separators is how the magnetic seed material is removed from the system for cleaning. In the CoMag system, the magnetic seed material (magnetite) is collected in the final electromagnetic collector, which is backwashed with water and air when it becomes loaded with suspended solids. Some magnetite is also collected in a pretreatment clarifier and then pumped to the magnetite cleaning system. In both cases, large amounts of water are used and therefore place a large load on the waste dewatering system.

The Sirofloc system is very similar to the CoMag system in this regard. Their magnetite cleaning system collects magnetite that is pumped from a clarifier and backwashed from a sand filter that serves as their final collector. These diluted wastes place a large load on the waste dewatering system.

A final known process of relevance is the so-called Actiflo system offered by Kruger, Inc. See Wong, “Using High-Rate Clarification Processes to Optimize Water Treatment”, Water World, June 2005. The Actiflo process is referred to as a ballasted flocculation process, wherein a polymer is used to attach coagulated particles to microsand for rapid settling. The microsand is separated from the sludge in a hydrocyclone and reused. As acknowledged in the Wong article, in this process the sludge stream is very dilute under typical circumstances, leading to a large load on the dewatering system.

### SUMMARY OF THE INVENTION

The present patent application discloses further improvements in methods and apparatus for separating composite particles, that is, non-magnetic pollutant particles that have been bonded by a flocculant to particles of magnetite or another magnetic material, from a water stream.

According to a first important aspect of the invention, vortex separation is combined with magnetic separation, and, in one preferred embodiment, both are performed in the same tank where flocculation occurs.

In one embodiment, the water stream to be treated, along with a quantity of magnetite and a flocculant polymer, is introduced at the lower extremity of a tank with a vortex separator above. Composite magnetic particles including the fine pollutant particles to be removed are thus formed first. The vortex separator causes a spiral upward flow to take place. The composite particles including magnetite are segregated because of the velocity differences in the vortex; that is, the more dense composite particles move to the center of the tank while the clear water moves to the edge of the tank, allowing the particle-laden and clear streams to be readily separated. Magnetic separation can then be performed on the clarified stream to remove any magnetic particles not separated out in the vortex separator.

As noted, it is conventional to use vortex separators for wet weather flow treatment, that is, treatment of either stormwater or CSO which is a combination of stormwater and sewage. It is recognized that this approach effectively removes large particles like grit and floatables, but does not effectively remove fine pollutant particles. Combining magnetic separation with vortex separation will greatly enhance the ability to lower pollutant levels to desired levels by removing pollutants of all sizes.

It is also usual to continuously clean all magnetic seed material collected from a clarifier or final magnetic collector. Research carried out by the present inventor has proven that this is not necessary. The magnetic seed material can be continuously used in a “dirty” state as long as new flocculating polymer is added to attach the new fine pollutant particles to the old pollutant particles that had been attached to the magnetic seed material. This makes it possible to eliminate a fixed magnetic cleaning system. Instead, for example, a mobile magnetic cleaning service can periodically come to the field location to clean the magnetic seed material and haul off the separated sludge for final disposal. Not cleaning the magnetite during operation of the magnetic separator is appropriate for intermittent service like stormwater or CSO.

According to another aspect of the invention, efficient operation is provided by a wet weather treatment system that utilizes magnetic seeding technology. Existing vortex separators that do a good job of removing grit and floatables but not fine pollutant particles could be retrofitted with a mixer to introduce the flocculant and a final magnetic collector to remove all pollutants from wet weather flows, after previously separating grit and floatables from CSO and stormwater. Where space constraints permit it, these capabilities can easily be incorporated into existing systems by the addition of an annular space between the outer tank wall and the floc chamber where the flocculant and magnetite is used. Water enters this annular space tangentially to the outer tank wall. Water then flows around the perimeter of the tank at a velocity that will allow grit to settle to the bottom and at the end of the annular space. Floatables will rise to the top of the annular space and be collected. Water will then exit from the annular space part way up the wall and enter the floc tank, for mixing of the flocculant polymer and magnetite, so that the composite magnetic particles are formed for subsequent removal using vortex and magnetic techniques. This will provide space and cost savings and is a novel approach to incorporate all cleaning requirements into one compact unit.

Removal of the composite magnetic particles from the water stream is a further challenge, and the present application discloses several efficient methods and equipment for doing so. Treating tens of thousands of gallons of water per minute as required in CSO systems, for example, requires a large final collector. Typical present designs for smaller flows use permanent magnets and some form of scraper to continuously clean the permanent magnets. More specifically, in traditional permanent magnet collectors, permanent magnets emitting a strong magnetic field are employed so as to reach far into a flowing stream of water to attract and collect the magnetite. Because the magnets are powerful, they hold the magnetite securely. Therefore a high force is required to clean the magnetite from the magnet using a scraper. It is desired to avoid use of such scrapers insofar as possible, as they are subject to wear and require excessive maintenance.

According to one aspect of the invention, the composite particles can be separated from the bulk of the water stream magnetically while avoiding the necessity of scraping them from a magnetized surface. In one embodiment, the strength of the magnetic field at the collecting surface is controlled and/or varied over time such that the magnetite is attracted to the collection surface and thus separated from the flowing water stream, but is not held so tightly that the magnetite cannot be moved along the surface in a desired direction. The magnetite then flows along the plate to a diverter point where it is separated from the main flow of water. This approach attracts the magnetic particles out of the flow of water but does not permanently collect them on a magnetized surface that would then need to be scraped clean. If this scraper-less magnet collector is oriented appropriately, the magnetite flow will be aided by gravity. This idea is especially beneficial in the design of a large flow system that would greatly benefit from a passive collector design.

One way of varying the magnetic field so as to encourage flow of the magnetic particles in a desired direction along a collection surface toward a separation point is simply to provide sequentially-actuated electromagnets disposed outside a conduit through which the water stream is directed. Another is to interrupt the magnetic field provided by permanent magnets. One way of doing so is to mount a number of permanent magnets in tubes of a diamagnetic material, that is, a material that does not allow a magnetic field to pass therethrough (e.g., certain stainless steels) disposed beneath a conduit containing the water stream. Slots would be cut along one side of each diamagnetic tube to expose the magnets, allowing the magnetic field to extend beyond the tube, attracting the composite particles, while the other side of the tube would act as a magnetic shield. Therefore when the open side of the diamagnetic tube faces the flowing stream water containing composite magnetic particles, the particles are collected on the plastic surface separating the collector from the water. When the collector tube is rotated, the magnetic field would be shielded and would then release the magnetic particles. The collector tubes could then be rotated in sequence along the desired direction of flow to allow the magnetic particles to flow from one collector to the next. This would clean the collectors with no physical scraper. This approach is inexpensive and mechanically simple because there is no need for a scraper to clean the magnetic collector.

In a further embodiment, a reciprocating permanent magnet collector that is self-cleaning with no need for mechanical scrapers is provided. The surface of the collector is a stationary plastic plate that has a serrated surface, that is, exhibits a sawtooth cross-section. Behind this surface is an oscillating magnetic plate. When the magnetic plate moves in one direction, it moves the magnetite in the same direction. When the direction of the magnetic plate movement is reversed, the magnetite remains in place because of the serrated surface of the plastic plate. An alternative approach is to keep the magnets stationary and oscillate the serrated plate. This approach is simple in design, keeping costs low, protects the magnets, and involves no scrapers, which is beneficial in large flow application.

A further embodiment uses magnetic balls to collect magnetite. The balls comprise an inner permanent magnet surrounded by a layer of buoyant foam to keep the balls afloat, on the surface of which the composite particles accumulate. The balls are surrounded by a non-ferrous cage to keep the balls separated. Once the balls have collected the magnetite they are raised from the water flow, preferably on a circular drum, and cleaned with a jet of water. Then the magnetic balls are returned to the water flow to collect more magnetite. This is a new design for a final collector in large flow applications that is simple and easily scalable.

As to each of these magnetic separators, the magnetic field must be strong enough to attract the composite magnetic particles. This can lead to difficulty in subsequently removing the composite magnetic particles. One way of reducing the strength of the magnetic field required is to design the water flow such that it is very turbulent, ensuring that all portions of the water stream are closely juxtaposed to the collecting surface.

Finally, the location of the magnetite cleaning system can have an impact on solids loading in the final magnetic collector. A new and innovative approach is to locate the drum that collects magnetite for cleaning in front of the final collector. In this way, solids are removed for cleaning from the water that is about to exit through the final magnetic collector.

### BRIEF DESCRIPTION OF THE DRAWINGS

The invention will be better understood if reference is made to the accompanying drawings, in which:

FIG. 1 is a perspective, partially cut-away view of a single piece of apparatus for removing settleable and floatable pollutants from the water stream in a first step, and then adding magnetic particles and a flocculant to the stream to cause composite magnetic particles to form, which are then removed from the water stream by a combination of vortex and magnetic separation techniques;

FIG. 2 shows a cross-sectional view of a two-stage apparatus for removing composite magnetic particles from a water stream;

FIG. 3 shows a schematic cross-section of another embodiment of apparatus for removing composite magnetic particles from a water stream;

FIG. 4 shows an enlarged partial perspective view of a portion of the FIG. 3 apparatus;

FIG. 5 shows a cross-sectional view of a magnetic collector assembly using an asymmetrically-serrated plate as a “ratchet” causing the magnetic particles to move in a desired direction for separation from a water stream;

FIG. 6 shows a perspective view of a magnetic ball assembly for collecting magnetic particles from a water stream; and

FIG. 7 shows a preferred apparatus for separating the magnetite particles from the collected pollutant particles and flocculant for reuse.

### DETAILED DESCRIPTION OF THE INVENTION

As described above, according to a first important aspect of the invention, vortex separation is combined with magnetic separation, and both are performed in the same tank. That is, the magnetic particles and the flocculant are introduced, and flocculation takes place, in the same tank where vortex separation is performed. The combination of these process steps in a single piece of apparatus makes it possible to design an efficient system to remove fine particles from large quantities of water. Actual separation of the composite magnetic particles formed upon flocculation may require an additional apparatus. In an alternative embodiment, useful where settleable solids such as silt, floating debris, and fine particles may all be present, this apparatus can further comprise equipment for removing settleable and floating pollutants as well.

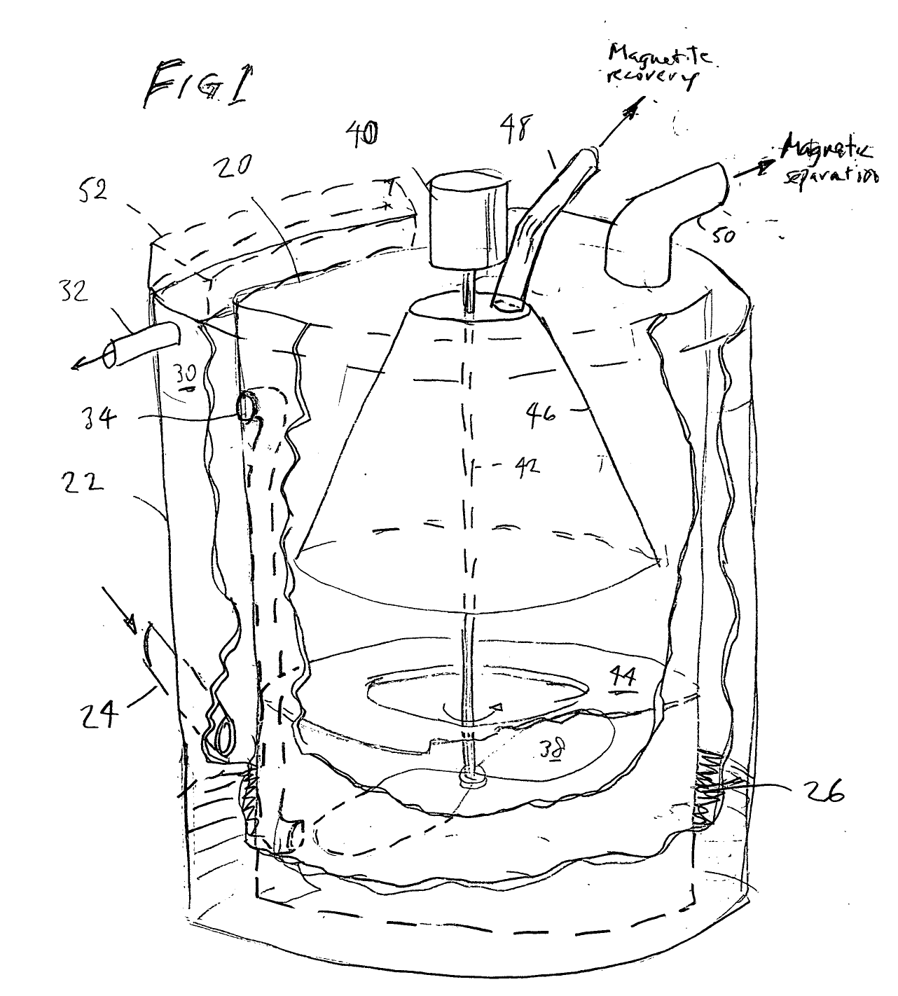

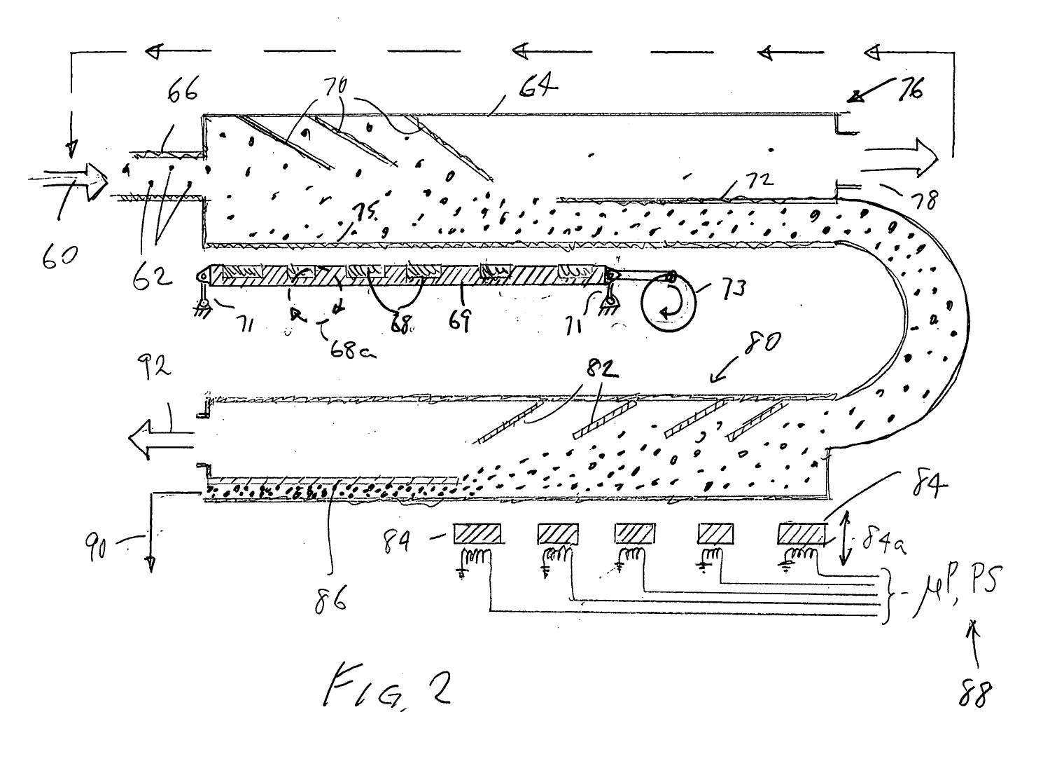

As noted, it is within the invention to refit certain preexisting equipment, e.g. existing vortex separators used for removing grit and the like from water streams, with additional equipment to provide additional capabilities. It will likely be feasible in many cases to retrofit existing vortex separation equipment with equipment for introduction of magnetite particles and a flocculant, so that composite magnetic particles including the fine pollutant particles to be removed are formed. It will then be possible to use the vortex separator to separate the stream into particle-rich and relatively clarified portions. The relatively clarified portion of the stream can then be “polished” using passive magnetic separation equipment as discussed in connection with FIGS. 2-5 as discussed below. In other cases it may also be possible and desirable to add equipment for initially removing much of the settleable and floatable pollutants from the stream prior to vortex separation, as in the FIG. 1 system.

As mentioned, the basic technique for removing fine pollutant particles from water that is employed according to the invention is to introduce a quantity of an organic polymer and of magnetic “seed” particles to the water stream, such that a floc consisting of composite particles of the magnetic material agglomerated with the particles to be removed is formed. The composite particles are denser than the water stream and tend to clump together, so that a particle-rich stream can be removed therefrom by vortex separation techniques; magnetic separation can be performed on the relatively-clarified portion of the stream exiting the vortex separator, for further polishing thereof. As noted, vortex separation involves the introduction of the stream of water into a cylindrical tank off-axis, so as to cause a spiral flow to take place. The composite particles including magnetite are segregated because of the velocity differences in the vortex; that is, the more dense particles move to the center of the tank while the clear water moves to the edge of the tank, allowing the particle-laden and clear streams to be readily separated. According to one aspect of the invention, this vortex action is accomplished in the upper levels of the tank in which the flocculating polymer is introduced, and therefore only requires one treatment tank.

In some cases, a flocculation mixer may be useful to aid in driving the circular flow, to ensure good mixing of the flocculant polymer and magnetic seed material, and to ensure sufficient flow velocity to cause the composite magnetic particles to rise to the top of the tank where they can readily be removed by magnetic techniques. For large flow applications, the mixer may not be necessary if the velocity of the water is sufficient to suspend the magnetite and provide good flocculation of the magnetic seed material with the pollutant particles. Further, as noted, where settleable solids such as silt or the like and/or floatable particles are also present, provision can be made for their simultaneous removal.

FIG. 1 shows a view of one possible embodiment of a magnetic separator with vortex flow according to the invention. The basic apparatus includes a tank 20 with an optional annular outer tank 22 for separation of settleable and floatable pollutants. Water to be cleaned enters the outer tank 22 at an inlet 24. Particles capable of settling out do so and are collected in the annular tank between the inner and outer tanks 20 and 22 respectively, as indicated at 26; they can be removed at intervals if the loading is not too great, or provision can be made for continuous removal and dewatering of the settled-out sludge. Floatable pollutants will rise to the top of the annular tank between the inner and outer tanks 20 and 22 respectively, as indicated at 30, and can be removed at an outlet 32. Alternatively, the floatables can be allowed to collect at the top of the annular space and then periodically be removed. Water with fine particles suspended therein passes from the annular tank into the inner tank 20 at an inlet 34; as illustrated, it may be desirable to dispose this inlet near the upper end of the annular tank, to allow maximum settling time for the settleable pollutants to settle out of the water stream, and then to pipe the water to the lower extremity of the inner tank. The flocculant, typically an organic polymer as noted, and the magnetic seed material can be introduced at the lower extremity of the tank 20. A flocculant mixer comprising a pair of blades 38 driven by a motor 40 via a shaft 42, is optionally provided to ensure thorough mixing, so that that the polymer flocculant effectively bonds the pollutant particles to the magnetic seed material, which is preferably magnetite. This portion of the tank is preferably provided with a baffle 44 to ensure effective mixing and flocculation. Then the water flows upwards into a portion of the tank where a vortex action, i.e. a spiral flow pattern, is formed with the help of a frustoconical baffle 46. Additional components, such as an additional motor driven paddle mixer, may be provided if necessary to ensure formation of the vortex flow pattern. The vortex action causes the high density composite magnetic particles to migrate to the center of the tank, such that a particle-rich stream flows upwardly to an exit 48, while the clarified water, that is, the vast majority of the water stream, migrates to the perimeter of the tank and exits at 50.

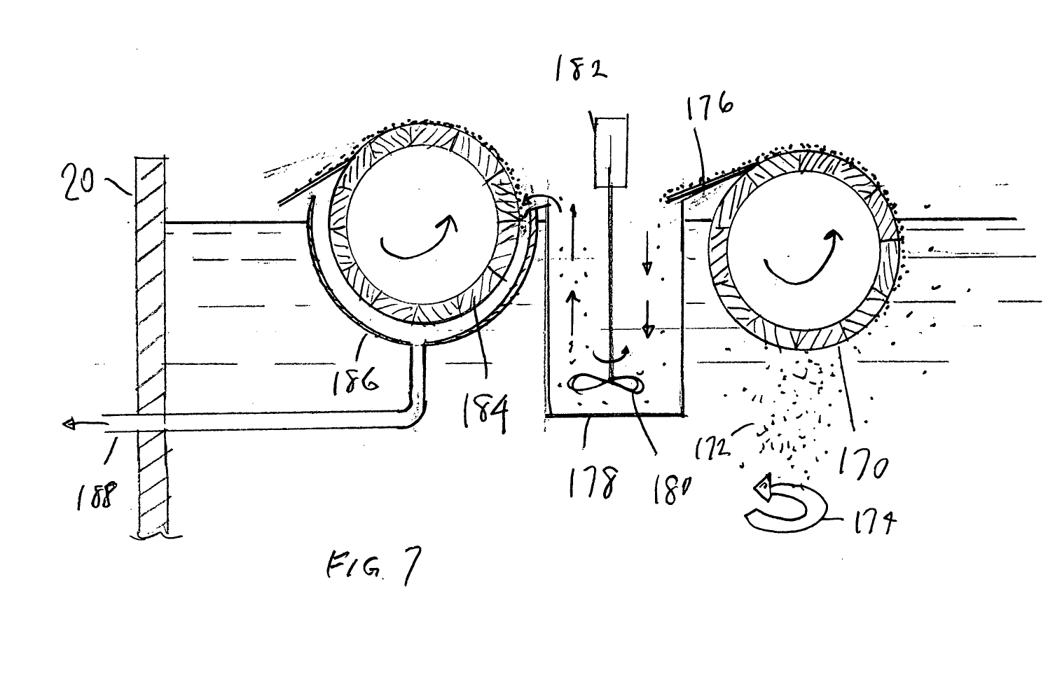

The clarified stream exiting the tank at 50 will then typically be “polished” by performance of magnetic separation, and can then be safely disposed of. As noted above, the clarified stream includes the vastly greater portion of the incoming water stream; accordingly, efficient polishing is critically important to economical operation. The apparatus designs shown in FIGS. 2-5 and discussed in detail below provide suitable performance. While these designs are shown as separate pieces of equipment for ease of illustration, the preferred embodiment would incorporate them into the unit of FIG. 1, e.g., these essentially linear designs could be disposed around the outer circumference of the top of the tank, as indicated schematically at 52. Alternatively, depending on the relative quantities of water to be processed, the magnetic separators could be mounted atop the tank. In a further alternative, the magnetic balls shown in FIG. 6 could be disposed directly in the tank, outside the frustoconical baffle 46.

The particle-rich stream collected at the center of the vortex separator at 48 can be treated in several alternative ways, depending on operational parameters. Specifically, it is generally desirable to treat the particle-rich stream so as to separate the magnetite from the flocculant and pollutant particles collected, so that the magnetite can be reused and the flocculant and pollutant disposed of separately. In units operated continuously, it may be preferred to provide a further unit for continuously collecting and cleaning the composite magnetic particles at the upper opening of the frustoconical baffle 46; the apparatus in FIG. 7 is suitable. In other cases, such as where the unit is only operated in response to stormwater conditions and the like, the concentrated stream of composite magnetic particles will typically be reintroduced into the water stream, with additional flocculant. After a wet weather event, with the flow stopped, the magnetite would settle to the bottom of the tank with most of it forming a pile in the middle of the tank. It is envisioned that a mobile treatment unit, comprising a device for separating the magnetite particles from the pollutant and flocculent, such that the magnetite can be further reused, would be employed to withdraw the collected magnetite and sludge from the tank. The dirty magnetite would be cleaned by the mobile unit with the sludge hauled off and the cleaned magnetite put back into the unit.

Thus, as noted above, vortex separators, operating on the principle of separating solids from water by the centrifugal forces created in a vortex, have been used, for example, to clean large flows from stormwater and combined sewer overflow (CSO) sources. The more dense solid particles are forced to the center of the vortex and the clear water migrates to the outside of the vortex. The main disadvantage of this technology as conventionally employed is that fine particles, e.g., less than 200 microns, are not dense enough to be effectively separated by the vortex separator in a reasonable residence time. According to the invention, a dense magnetic seed material (e.g. magnetite) and a flocculant are added to enhance the removal of fine particles from the wastewater using vortex separation techniques, by increasing the density of the pollutant particles, and likewise permitting magnetic separation techniques also to be used.

It is within the invention to add equipment for introducing magnetite and flocculant to existing equipment for vortex separation, and to provide magnetic separation equipment to treat the clarified stream. It is also within the invention (where space constraints permit) to add an annular outer tank to a preexisting vortex separator as used for removal of grit, to instead collect the grit in the annular outer tank and used the vortex separator to concentrate the magnetic particles formed by flocculation in the tank. Finally, it is also within the invention to add an inner tank to an outer tank now used for vortex separation, to provide a similar structure.

Present magnetic separation technologies typically clean all magnetic seed material collected from a clarifier or final magnetic collector for reuse. The inventor has shown by laboratory tests that this is not necessary. The magnetic seed material can be used in a dirty state, i.e., as part of a composite particle including the polymer flocculant and the pollutant particle to be removed, for long periods, if new flocculating polymer is added to attach the new fine pollutant particles to the old pollutant particles that had been attached to the magnetic seed material. This is important because it makes it possible to completely eliminate a permanent magnetic cleaning system for some applications.

For example, with stormwater and CSO applications that only operate intermittently during wet weather events, a vortex separator can be operated for long periods until the magnetic seed material requires cleaning. Periodically, the magnetic seed material can be cleaned and replaced, and the separated sludge removed for final disposal. Not cleaning the magnetite during operation of the magnetic separator is appropriate for intermittent service like stormwater or CSO. Typical existing vortex separators that do a good job of removing grit and floatables but not fine pollutant particles could be retrofitted with a flocculant mixer and a final magnetic collector to implement the invention and thus remove all pollutants from wet weather flows. The advantage of this approach is lower capital cost and less equipment to maintain.

Thus, it is within the invention to clean the magnetic seed material only periodically, as needed. It is envisioned that this could be efficiently accomplished employing a cleaning vehicle that would come to the site and perform several functions, including pumping out floatables and grit for disposal, and pumping the dirty magnetic seed material from the treatment tank into a cleaning system, where the pollutants removed by magnetic and vortex separation techinques can be separated from the magnetic seed material, which is then returned to the vortex treatment system. In the preferred embodiment the cleaning system is similar to the system depicted in FIG. 7. Using a magnetic separation step in the cleaning process greatly reduces the amount of waste for disposal so it becomes possible to economically transport waste from the treatment site to a final disposal site. In another embodiment, the mobile system could also contain a filter that would take the waste to dryness which would be preferable if the final disposal facility was not located nearby.

As noted, passive systems for the treatment of high water flows such as municipal, stormwater, drinking water, or CSO, which require the treatment of tens of thousands of gallons of water per minute require a large final collector for removal of the composite magnetic particles from the processed water stream. In such designs as conventionally used the composite particles are dispersed throughout the entire water stream, so that the entire stream must be processed magnetically. According to a first improvement made by the invention, the bulk of the composite particles are removed by vortex separation, as above, so that less magnetite need be removed by magnetic methods. In a further improvement according to the present invention, equipment is provided enabling more efficient magnetic separation. Typical designs for magnetic separators involve permanent magnets and some form of scraper to continuously clean the permanent magnets. In the typical design of a traditional permanent magnet collector, powerful magnets are used so that the magnetic field extends far into the water flow to attract and collect the magnetite. The powerful magnets hold the magnetite securely, so that it is necessary to use a lot of force with the scraper to remove the magnetite.

There are many different configurations of equipment that will permit a magnetic field to stratify magnetic particles in a moving stream of water yet allow the particles to continuously or intermittently move towards a device in the moving stream of water that separates the stratified layer of magnetic particles from the clarified water. According to the invention, such devices will desirable be passive, that is, avoid use of mechanical scrapers. The magnetic field strength is controlled to be strong enough to attract the particles through the stream, while the particles move in a desired direction of flow, so that the particle-rich portion of the stream can be separated effectively from the relatively clarified portion. Control of the magnetic field can be accomplished in several ways, discussed in detail below. The separator device can be any device that will separate a stratified layer of magnetic particles from clarified water. In its simplest form, a diverter plate can be employed to separate one stream into two, one of the separated streams being clarified water and the other stream of water containing most of the composite magnetic particles, that is, again, particles of a magnetic material such as magnetite with the pollutant particles to be removed bound thereto by a flocculant.

FIG. 2 shows a separator apparatus that provides two successive stages of separation; in each, the water stream is stratified into two portions, one in which the composite magnetic particles are relatively concentrated and one from which the particles are largely absent. In a first separator apparatus 76, a stream 60 of water containing composite magnetic particles 62 (again, typically magnetite seed particles with the pollutants bound thereto by a flocculant or the like) flows into a conduit 64 at an entry 66. Magnets 68 (which can be permanent magnets or electromagnets) are disposed along the lower surface of the conduit, attracting the magnetic particles downwardly, thus forming a stratified flow pattern, with the magnetic particles in the water stream flowing in the lower portion of the conduit and clarified water flowing above. The particles will also experience natural settling because of their high density. Deflector vanes 70 are used to divert the water stream in the downward direction to ensure that the magnetic particles will be effectively attracted toward the permanent magnets, and to cause turbulent flow in the conduit, which is similarly desirable, again to ensure that the magnetic particles will quickly pass within the effective collecting range of the permanent magnets.

As the stratified water stream including the magnetic particles flows along the bottom of the conduit 64, it then flows under a separator baffle 72 extending across the conduit. The clarified stream exiting the upper portion of conduit 64 at 78 will likely include some composite particles as illustrated and can be returned to the entry port 66 for further processing if desired. The separator baffle 72 diverts the portion of the stream containing the composite magnetic particles to a second similar concentration stage 80, again comprising diverter baffles 82, magnets 84 and separator baffle 86. Second concentrator stage 80 further concentrates the stream of water containing the bulk of the composite magnetic particles to make dewatering and cleansing of the seed material of the flocculant and pollutant particles for reuse more feasible. This stream is collected at 90, while the cleansed stream of water exits at 92.

Several factors can be controlled to ensure that the magnetic particles move in the correct direction. First, the force of the flow can be controlled, at least approximately, by adjusting the width of the conduit. Frictional forces are not easily controlled directly, but are primarily a function of the magnetic forces, the gravity forces, and the surface roughness of the conduit containing the water. Preferably, the inside lower surface of the conduit, against which the particles collect, is formed of a low-friction plastic material. However, the most readily controllable force affecting the magnetic particles is the magnetic force. Therefore, the configuration of the magnets 68 and 84, the strength of the magnetic field emitted (if electromagnets are used) and the distance between the magnets and the surface of the conduit toward which the magnetic particles are attracted, can all be controlled, singly or in combination, to control the magnetic force exerted and thus the degree to which the particles are attracted to and impeded by the interaction with the surface of the conduit. There are many mechanical ways to controllably change the distance between the magnets and the particles in the water, so as to urge the magnetic particles to move in a desired direction. For example, if a number of permanent magnets 68 are mounted in a carrier 69 that is mounted on parallelogram linkages 71 for being driven as indicated at 73, that is, such that carrier 69 remains parallel to the collection surface 75 formed by the bottom of the conduit 64, while each magnet makes a circular path as indicated by arrow 68a, the magnetic field emitted by each magnet 68 will tend to move the magnetic particles rightwardly.

Another basic way to control the magnetic forces in the system, and more specifically to induce a magnetic force varying along the length of the conduit, so as to move the magnetic particles in a desired direction of flow, is to use electromagnets to provide a spatially-varying magnetic field. For example, a set of individually-controlled electromagnets 84 can be provided and sequentially deactivated along the desired direction of flow, to cause clumps of the magnetic particles to be released from one region of the collecting surface (that is, the floor of the conduit) and attracted to the next, causing the composite magnetic particles to flow step-wise towards the exit end of the conduit, under the separator baffle 72. FIG. 2 indicates this specifically by illustrating electromagnets 84 separately connected to a control device indicated at 88, typically comprising a microprocessor μP and power supply PS. The current to the electromagnets 84 can also be controlled to reduce the magnetic field generated. Sequencing the power off to individual electromagnets may be the best approach because this approach will allow a large magnetic field to be employed in order to ensure the composite particles are effectively attracted to the bottom of the conduit, for stratifying the flow, while deactivating the electromagnets periodically will allow the particles to be entrained with the water stream and removed from the conduit 64.

The effectiveness of using a multistage process to concentrate magnetic particles from a moving stream of water is explained as follows. In a flowing stream of water that is 6 inches deep, a separator baffle 72 defining an opening one half inch high to separate the stratified magnetic particles will reduce the volume of the treated water by almost 92%. Repeating this process reduces a 10,000 gpm flow to about 70 gpm. If substantially 100% of the magnetic particles are recovered in the separated stream, as is possible according to the invention, the removal of magnetic particles from this relatively small quantity of water for cleaning is manageable in a traditional magnetic drum collector (see FIG. 7) which will produce a wet solid that is low in free water. Additional stages can be added to reduce the volume of greater flows.

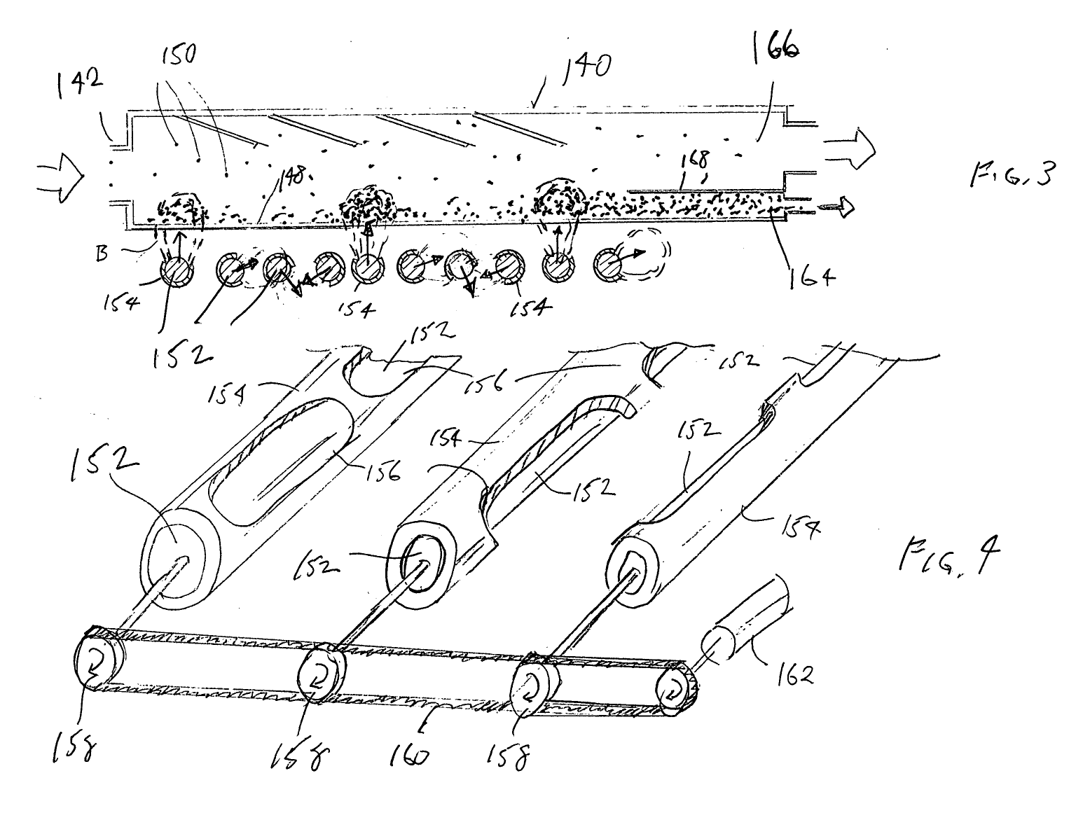

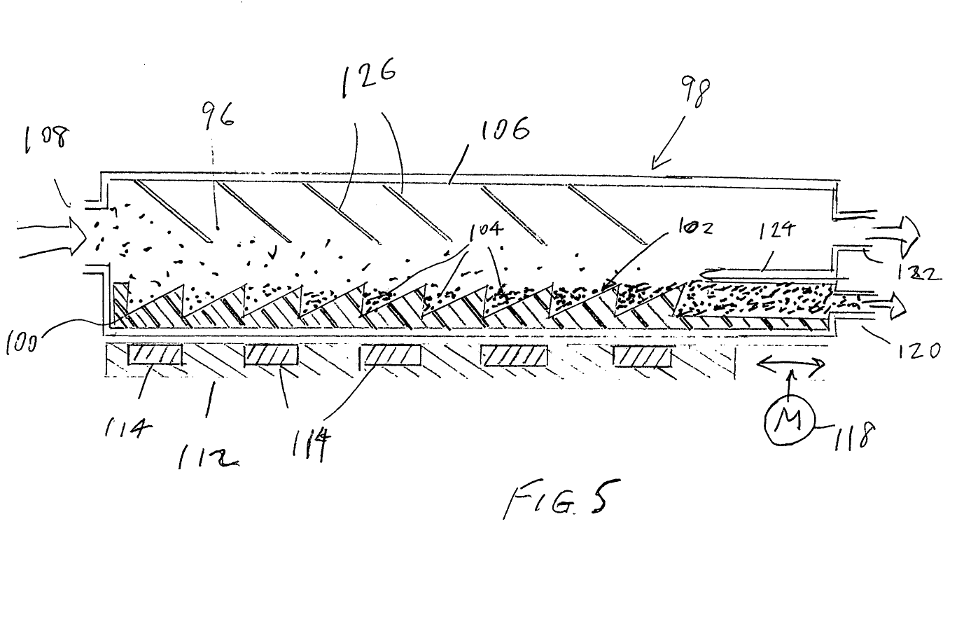

Another way to provide a magnetic field that varies with time so as to cause magnetic particles to be stratified within the water stream, so as to be readily separated, while simultaneously moving the particles toward an exit, is shown in FIGS. 3 and 4. In this embodiment, the function of sequentially actuating magnets so as to progressively exert magnetic forces urging the composite magnetic particles in a desired direction of flow is provided by permanent magnets that are controllably shielded, so that their magnetic fields similarly exert force urging the particles in the desired direction of flow. FIG. 3 shows a schematic cross-section of the apparatus, including a number of cylindrical permanent magnets disposed within perforated diamagnetic tubes extending transverse to the conduit in which the water stream flows, while FIG. 4 shows an enlarged partial perspective view of the magnets and perforated tubes and schematically shows the motor and drive apparatus rotating the tubes. Thus, in FIG. 3, the water containing the composite particles 150 to be removed is admitted to a conduit 140 at an inlet 142. As in the FIG. 2 device, baffles 144 may be provided to cause turbulence and to ensure that all portions of the water stream are juxtaposed to the lower collection surface 148, which may be lined with a low-friction plastic material or the like. Beneath the collection surface 148 are disposed a number of transverse cylindrical permanent magnets 152, which are mounted within perforated tubes 154 of a diamagnetic magnetic material, that is, a material which does not permit a magnetic field to pass therethrough, such as certain stainless steels. Accordingly, while magnets 152 emit a magnetic field B in all directions, the field only escapes the tubes 154 through the perforations 156. Thus as illustrated, the field B from a given magnet 152 only penetrates the collection surface 148 to the extent that the perforation 156 is juxtaposed thereto. Accordingly, if a number of such magnet and tube assemblies are provided, with the perforations successively phased clockwise around the magnets, and the assemblies are then rotated synchronously (as indicated by drive pinions 158, belt 160, and motor 162 in FIG. 4) the magnetic fields B within the conduit will effectively move rightwardly, causing the magnetic particles 150 to be attracted toward the collection surface 148 and move therealong. That is, the particles are thus concentrated so that a particle-rich stream 164 can be separated from a clarified stream 166 by a baffle 168.

Additional methods for magnetically separating the composite particles from the bulk of the water stream, thus concentrating the pollutants for convenient further processing and disposal, are discussed below. More specifically, there are many different configurations of equipment that will permit a magnetic field to stratify magnetic particles in a moving stream of water yet allow the particles to continuously or intermittently move towards a device in the moving stream of water that separates the stratified portion of the stream containing most of the composite magnetic particles from the clarified portion of the water stream. The separator device can be any device that will separate a stratified layer of magnetic particles from clarifier water.

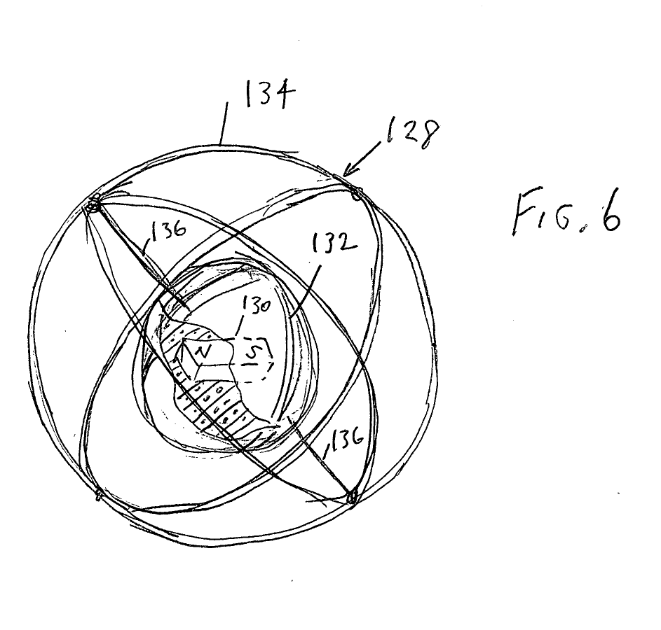

As above, scrapers used to scrape magnetic particles from a magnetized collection surface wear out due to the abrasive affect of magnetite and have to be replaced, in particular because effective separation requires substantial magnetic forces and concomitantly large forces to scrape the magnetized particles from the collection surface. FIG. 5 shows in cross-section a reciprocating permanent magnet collector 98 that is self-cleaning with no need for scrapers. The collection surface of the collector is formed of a stationary non-ferrous, preferably plastic, member 100 that has a serrated (sawtooth) surface 102, forming transverse collection troughs 104 that are asymmetric in cross-section, as shown, having gentle slopes in the direction of flow (rightwardly in the embodiment shown) and vertical walls opposing flow in the other direction. Member 100 is disposed in a conduit 106 with an entry 108 by which the stream of water containing composite magnetic particles 96 is introduced. Below the conduit is disposed a magnet carrier 112 in which a plurality of permanent magnets 114 are disposed; carrier 112 is driven for reciprocation by a motor 118. Magnets 114 may be disposed opposite the collection troughs 104, in which the magnetic particles accordingly tend to collect. Thus, when the magnetic carrier 112 is moved in the direction of flow, that is, rightwardly in the drawing, the magnetic particles are caused to move rightwardly, from one trough to the next. When the direction of the magnet carrier is reversed, that is, when the magnet carrier moves leftwardly, the magnetite remains in place because of the asymmetric serrated surface of the plastic plate. (It is of course equivalent to reciprocate the serrated collector with respect to stationary magnets.) It would also be possible to move the magnet carrier away from the collection troughs, reducing the magnetic force exerted, when moving the carrier opposite the direction of flow, so that the net tendency would be to move the magnetic particles in the direction of flow. In a further alternative, sequentially-controlled electromagnets could be similarly employed. Thus, as illustrated the concentration of the particles 96 builds up over the length of the collector 98; when the particles reach the right end of the collector 98, they are removed by entrainment in a small portion of the water stream though an exit port 120, while the cleansed portion of the stream exits at 122. A separator baffle 124 and turbulence-inducing baffles 126 may be provided, as above, and multiple units 98 connected in parallel and serial fashion as needed to obtain a desired degree of separation of a desired quantity of flow. This collector assembly has several advantages: (1) it is simple in design to keep costs low, (2) it isolates the magnets from the water stream, (3) power requirements are low, and (4) scrapers are avoided.

Another possibility is to use magnetic balls 128 to collect the composite magnetic particles. A typical design is shown in FIG. 6. An inner permanent magnet 130 is encased in a spherical ball 132 of buoyant foam to keep the balls afloat. Then the foam ball 132 would be surrounded by a non-ferromagnetic spherical wire cage 134, the foam ball 132 being supported in the center of the wire cage by a transverse member 136 that would keep the foam balls 132 separated. A plurality of such balls 128 could be disposed in a tank containing water containing the composite particles, e.g., inside the conical vortex baffle 46 in the inner tank 20 of FIG. 1, and the composite particles would be attracted to and retained on the surface of the inner foam ball 132. From time to time, when the balls 128 have collected a substantial quantity of the magnetic particles, they would be collected and cleaned with a jet of water. Then they would be returned to the water flow to collect more magnetic particles.

As noted above, in some operational circumstances it will be preferred to continuously remove the composite particles accumulated at the center of the vortex separator of FIG. 1 from the water stream, and separate the magnetite from the pollutants and flocculant, so as to reuse the magnetite seed material. FIG. 7 shows an apparatus which would be suitable for being disposed at the center of the vortex separator of FIG. 1, that is, in tank 20, for this purpose. As noted above, the vast bulk of the water stream flows outside baffle 46, while a particle-rich stream 172 is concentrated at the center of the vortex (indicated at 174). A rotating drum magnet 170 is located so that this particle-rich stream impacts it directly, so that the magnetic particles are efficiently collected on its surface. As drum 170 rotates, its surface is scraped clean by a scraper 176 (the flow rate here is sufficiently slow that wear of the scraper and drum is not the problem it would be if scrapers were employed in lieu of the passive separators of FIGS. 2-5, i.e., to remove magnetic particles from the bulk of the water stream.) The composite particles are scraped into a shear tank 178. A high-shear mixer 180 driven by a motor 182 causes the floc to break, that is, the turbulence imparted by mixer 180 is sufficient to cause the magnetite particles to be physically detached from the pollutant particles and the flocculant, leaving a combined mixture thereof. The overflow from shear tank 178 falls onto a second rotating magnetic drum 184 supported above a trough 186. Drum 184 collects the clean magnetite from the mixture, while the nonmagnetic particles and flocculant form a sludge that falls to the bottom of trough 186 and is withdrawn for disposal at 188. The magnetite adhering to the second magnetic drum 184 is scraped off by a second scraper 190, and falls back into the floc tank for reuse.

While several alternative embodiments of the invention have been disclosed, the invention should not be limited thereby, but only by the following claims.

What is claimed is:

1. A method for removal of fine pollutant particles from a stream of water, comprising the steps of:
introducing the stream of water into a tank;
introducing a quantity of magnetic seed particles and a flocculant into said tank, under conditions that encourage mixing of the magnetic seed particles and flocculant with the pollutant particles and consequent formation of composite magnetic particles in said stream;
introducing said stream with composite magnetic particles therein into a vortex separator also disposed in said tank, whereby said stream is separated into a particle-rich portion and a relatively clarified portion; and
introducing said relatively clarified portion into a magnetic separator unit, for removal of any remaining composite magnetic particles from said clarified portion of said stream.

2. The method of claim 1 wherein the fine pollutant particles include metal precipitates, organic solids, inorganic solids, clays, silts, oil and grease.

3. The method of claim 1 wherein the waters to be thus treated include industrial wastewater, municipal wastewater, potable water, combined sewer overflow, storm water, process water, and cooling water.

4. The method of claim 1, wherein said magnetic separator unit comprises an elongated, horizontal conduit having an entry port at one end for introduction of a stream of water containing composite magnetic particles, a plurality of magnets disposed beneath a lower collection surface of said conduit, against which said magnetic particles are urged by said magnets, and first and second exit ports at an opposite end of said conduit, said first and second exit ports being disposed on either side of a separator device for separating a particle-rich portion of the stream flowing along said lower collection surface from a clarified portion of said stream flowing in an upper portion of said conduit.

5. The method of claim 4, wherein said plurality of magnets of said magnetic separator unit are controlled so that the magnetic field emitted thereby varies along the length of said collection surface so as to urge the magnetic particles to flow therealong.

6. The method of claim 5, wherein said magnets are electromagnets and are sequentially energized in order to vary the magnetic field emitted thereby so as to urge the magnetic particles to flow along said collection surface.

7. The method of claim 5, wherein said magnets are permanent magnets, the positions of which are mechanically varied with respect to said collection surface so as to vary the magnetic field emitted thereby so as to urge the magnetic particles to flow along said collection surface.

8. The method of claim 5, wherein said magnets are generally cylindrical permanent magnets mounted in tubes of diamagnetic material having elongated slots formed therein, whereby the magnetic field emitted by the magnets can be blocked responsive to the orientation of said slots, and whereby the positions of said slots with respect to the collection surface is varied by rotation of said tubes in order to vary the magnetic field emitted thereby so as to urge the magnetic particles to flow along said collection surface.

9. The method of claim 5, wherein said collection surface of said conduit is formed to define transverse collection troughs each having an asymmetrical cross-sectional shape, whereby by oscillating the magnets beneath the collection surface with respect thereto, the magnetic particles are urged to move from one collection trough to the next, and thus to the outlet of the conduit.

10. The method of claim 4, wherein said conduit is provided with means for inducing turbulence in water flowing therein, so as to ensure that substantially all portions of the water stream are juxtaposed to said collection surface.

11. The method of claim 10, wherein said means for inducing turbulence in water flowing in said conduit comprise baffles for directing the flow of water.

12. The method of claim 1, wherein magnetic balls, comprising a permanent magnet embedded in a generally spherical ball of buoyant foam, are disposed in said tank for collection of composite magnetic particles on the surface of said foam ball.

13. The method of claim 12, wherein said foam balls are surrounded by a non-ferromagnetic wire cage to ensure that the foam balls are spaced from one another.

14. The method of claim 1, comprising the further step of treating said particle-rich portion of the stream in order to separate the composite particles from the stream and to separate the magnetic seed particles from the pollutant particles and flocculant.

15. The method of claim 14, wherein said step of separation of the composite particles from the stream is performed by juxtaposing a magnetic drum to said particle-rich stream and subsequently scraping the composite particles therefrom.

16. The method of claim 15, wherein said step of separating the magnetic seed particles from the pollutant particles and flocculant is performed by admitting the composite magnetic particles to a high-shear mixer, so as to physically break up the composite particles and form a combined mixture including the magnetic seed particles and the pollutant particles and flocculant, and subsequently magnetically removing the magnetic seed particles therefrom.

17. The method of claim 16, wherein the step of magnetically removing the magnetic seed particles from the pollutant particles and flocculant is performed by dispensing the mixture including the magnetic seed particles and the pollutant particles and flocculant onto the surface of a second magnetic drum, whereby the magnetic seed particles are separated from the mixture for reuse and the pollutant particles and flocculant may be separately disposed of.

18. Apparatus for removal of fine pollutant particles from a stream of water, comprising:
a generally circular tank having an off-axis inlet near its lower extremity for admitting the water stream to be treated;
means for introducing a quantity of magnetic seed particles and a flocculant into said tank under conditions that encourage mixing of the magnetic seed particles and flocculant with the pollutant particles and consequent formation of composite magnetic particles in said stream;
a vortex separator also disposed in said tank, whereby said stream is separated into a particle-rich portion and a relatively clarified portion; and
a magnetic separator unit, for removal of any remaining composite magnetic particles from said clarified portion of said stream.

19. The apparatus of claim 18 wherein the fine pollutant particles to be removed include metal precipitates, organic solids, inorganic solids, clays, silts, oil and grease.

20. The apparatus of claim 18 wherein the waters to be thus treated include industrial wastewater, municipal wastewater, potable water, combined sewer overflow, storm water, process water, and cooling water.

21. The apparatus of claim 18, wherein said magnetic separator unit comprises an elongated, horizontal conduit having an entry port at one end for introduction of a stream of water containing composite magnetic particles, a plurality of magnets disposed beneath a lower collection surface of said conduit, against which said magnetic particles are urged by said magnets, and first and second exit ports at an opposite end of said conduit, said first and second exit ports being disposed on either side of a separator device for separating a particle-rich portion of the stream flowing along said lower collection surface from a clarified portion of said stream flowing in an upper portion of said conduit.

22. The apparatus of claim 21, wherein said plurality of magnets of said magnetic separator unit are controlled so that the magnetic field emitted thereby varies along the length of said collection surface so as to urge the magnetic particles to flow therealong.

23. The apparatus of claim 22, wherein said magnets are electromagnets and are sequentially energized in order to vary the magnetic field emitted thereby so as to urge the magnetic particles to flow along said collection surface.

24. The apparatus of claim 22, wherein said magnets are permanent magnets the positions of which are mechanically varied with respect to said collection surface so as to vary the magnetic field emitted thereby so as to urge the magnetic particles to flow along said collection surface.

25. The apparatus of claim 22, wherein said magnets are generally cylindrical permanent magnets mounted in tubes of diamagnetic material having elongated slots formed therein, whereby the magnetic field emitted by the magnets can be blocked responsive to the orientation of said slots, and whereby the positions of said slots with respect to the collection surface is varied by rotation of said tubes in order to vary the magnetic field emitted thereby so as to urge the magnetic particles to flow along said collection surface.

26. The apparatus of claim 22, wherein said collection surface of said conduit is formed to define transverse collection troughs each having an asymmetrical cross-sectional shape, whereby oscillating the magnets beneath the collection surface with respect thereto, the magnetic particles are urged to move from one collection trough to the next, and thus to the outlet of the conduit.

27. The apparatus of claim 21, wherein said conduit is provided with means for inducing turbulence in water flowing therein, so as to ensure that substantially all portions of the water stream are juxtaposed to said collection surface.

28. The apparatus of claim 27, wherein said means for inducing turbulence in water flowing in said conduit comprise baffles for directing the flow of water.

29. The apparatus of claim 18, wherein magnetic balls, comprising a permanent magnet embedded in a generally spherical ball of bouyant foam, are disposed in said tank for collection of composite magnetic particles on the surface of said foam ball.

30. The apparatus of claim 29, wherein said foam balls are surrounded by a non-ferromagnetic wire cage to ensure that the foam balls are spaced from one another.

31. The apparatus of claim 18, further comprising apparatus for treating said particle-rich portion of the stream in order to separate the composite particles from the stream and to separate the magnetic seed particles from the pollutant particles and flocculant.

32. The apparatus of claim 31, wherein said apparatus for treating said particle-rich portion of the stream in order to separate the composite particles from the stream comprises a rotating magnetic drum for collecting the particles from said particle-rich stream and a scraper for subsequently scraping the composite particles therefrom.

33. The apparatus of claim 32, further comprising a high-shear mixer, for physically breaking up the composite particles and forming a combined mixture including the magnetic seed particles and the pollutant particles and flocculent, and subsequently magnetically removing the magnetic seed particles therefrom.

34. The apparatus of claim 33, further comprising apparatus for dispensing the mixture including the magnetic seed particles and the pollutant particles and flocculant onto the surface of a second rotating magnetic drum, whereby the magnetic seed particles are separated from the mixture for reuse, whereby the pollutant particles and flocculant may be separately disposed of.

35. A magnetic separator unit for removing magnetic particles from a large quantity of water, comprising an elongated, horizontal conduit having an entry port at one end for introduction of a stream of water containing composite magnetic particles, a plurality of magnets disposed beneath a lower collection surface of said conduit, against which said magnetic particles are urged by said magnets, and first and second exit ports at an opposite end of said conduit, said first and second exit ports being disposed on either side of a separator device for separating a particle-rich portion of the stream flowing along said lower collection surface from a clarified portion of said stream flowing in an upper portion of said conduit.

36. The magnetic separator unit of claim 35, wherein said plurality of magnets of said magnetic separator unit are controlled so that the magnetic field emitted thereby varies along the length of said collection surface so as to urge the magnetic particles to flow therealong.

37. The magnetic separator unit of claim 36, wherein said magnets are electromagnets and are sequentially energized in order to vary the magnetic field emitted thereby so as to urge the magnetic particles to flow along said collection surface.

38. The magnetic separator unit of claim 36, wherein said magnets are permanent magnets the positions of which are mechanically varied with respect to said collection surface so as to vary the magnetic field emitted thereby so as to urge the magnetic particles to flow along said collection surface.

39. The magnetic separator unit of claim 36, wherein said magnets are generally cylindrical permanent magnets mounted in tubes of diamagnetic material having elongated slots formed therein, whereby the magnetic field emitted by the magnets can be blocked responsive to the orientation of said slots, and whereby the positions of said slots with respect to the collection surface is varied by rotation of said tubes in order to to vary the magnetic field emitted thereby so as to urge the magnetic particles to flow along said collection surface.

40. The magnetic separator unit of claim 36, wherein said collection surface of said conduit is formed to define transverse collection troughs each having an asymmetrical cross-sectional shape, whereby by oscillating the magnets beneath the collection surface with respect thereto, the magnetic particles are urged to move from one collection trough to the next, and thus to the outlet of the conduit.

41. The magnetic separator unit of claim 35, wherein said conduit is provided with means for inducing turbulence in water flowing therein, so as to ensure that substantially all portions of the water stream are juxtaposed to said collection surface.

42. The magnetic separator unit of claim 41, wherein said means for inducing turbulence in water flowing in said conduit comprise baffles for directing the flow of water.
